(19) United States
(12) Patent Application Publication
(10) Pub. No.: US 2026/0072738 A1
(43) Pub. Date: Mar. 12, 2026

(54) METHOD AND SYSTEM FOR MANAGING CPU POWER STATES FOR HETEROGENEOUS VIRTUALISED WORKLOADS

(71) Applicant: NEC Laboratories Europe GmbH, Heidelberg (DE)

(72) Inventors: Hammad ZAFAR, Heidelberg (DE); Faqir Zarrar YOUSAF, Heidelberg (DE); Girma Mamuye YILMA, Heidelberg (DE)

(21) Appl. No.: 19/106,649

(22) PCT Filed: Dec. 27, 2023
(86) PCT No.: PCT/EP2023/087862

§ 371 Date: Feb. 26, 2025

(30) Foreign Application Priority Data
Feb. 27, 2023 (EP) 23158853

(51) Int. Cl. G06F 9/48; G06F 9/50; H04L 41/40

(52) U.S. Cl. CPC G06F 9/4893; G06F 9/5061; G06F 9/5094; H04L 41/40

(57) ABSTRACT

A method manages virtual network function components (VNFCs) in a compute infrastructure of a virtualized environment. The method includes performing, by an orchestrator system of the virtualized environment, power state-based resource pooling in the compute infrastructure based on central processing unit (CPU) power state management policies; and scheduling, by a scheduler, virtual CPUs (vCPUs) of the VNFCs on physical cores of appropriate resource pools whose CPU power states match with power profile characteristics of the vCPUs.

### CROSS REFERENCE TO RELATED APPLICATIONS

This application is a U.S. National Phase application under 35 U.S.C. § 371 of International Application No. PCT/EP2023/087862, filed on Dec. 27, 2023, and claims benefit to European Patent Application No. 23158853.4, filed on Feb. 27, 2023. The International Application was published in English on Sep. 6, 2024 as WO 2024/179716 A1 under PCT Article 21(2).

### FIELD

The present invention relates to power state management in a compute infrastructure for large-scale virtualized environments, such as network function virtualization (NFV) or virtualized radio access network vRAN, and provides methods and systems for managing virtual network function components (VNFCs) in a compute infrastructure of a virtualized environment.

### BACKGROUND

Energy efficiency and overall power consumption optimization are significant objectives for large-scale telecom network deployments, consisting of hundreds of virtualized network functions and components. These virtual network functions (VNFs) can be deployed in multiple sites, further comprising of several VNFCs deployed on the virtualized infrastructure. Achieving the objective of energy-efficiency and overall power conservation in such a large network requires a set of energy-efficient orchestration polices and optimal power management mechanisms working on multiple levels in close coordination.

Usually, an entity responsible for the management and orchestration is tasked with managing the overall network resources and orchestrating new network services and functions over the underlying virtualized infrastructure. For example, within an NFV framework 100 (as illustrated in FIG. 1, obtained from ETSI GS NFV-006—Network Functions Virtualisation (NFV) Release 4; Management and Orchestration; Architectural Framework Specification), Network Functions Virtualisation Management and Orchestration (NFV-MANO) 110 is responsible for orchestrating VNFs 120 and Network Services (NS), and managing virtualized resources in the underlying NFV infrastructure (NFVI) 130. Another example is the Service Management and Orchestrator (SMO), which oversees the orchestration and management aspects of RAN elements in open radio access network (O-RAN) architecture. These orchestration and management entities have the global view of the system, i.e., the underlying infrastructure and the workloads running over it, and, as such, they are in a suitable position to make optimal decisions with the objective of overall power conservation.

In NFV deployments, multiple vCPUs belonging to different VNFCs and VNFs/NSs may share the same physical central processing unit (CPU) cores in the NFVI on a time-sharing basis. Each VNFC may have its own power and performance requirements depending on the functionality and purpose of the VNF it belongs to. An NFVI subsystem configured to dynamically adjust CPU P-states in such scenario can lead to conflicts between physical processor's P-state and the desired P-state of the vCPU scheduled on that physical core.

### SUMMARY

In an embodiment, the present disclosure provides a method for managing virtual network function components (VNFCs) in a compute infrastructure of a virtualized environment. The method includes: performing, by an orchestrator system of the virtualized environment, power state-based resource pooling in the compute infrastructure based on central processing unit (CPU) power state management policies; and scheduling, by a scheduler, virtual CPUs (vCPUs) of the VNFCs on physical cores of appropriate resource pools whose CPU power states match with power profile characteristics of the vCPUs.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating a NFV architectural framework according to prior art;

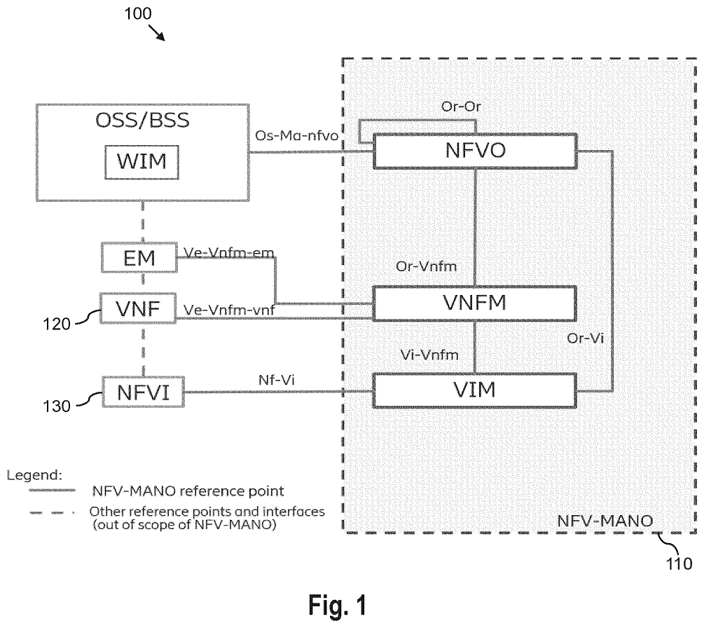

FIG. 2 is a schematic view illustrating power state-based zones in the infrastructure layer according to an embodiment of the present disclosure;

FIG. 3 is a schematic view illustrating power state aware orchestration in NFV and O-RAN according to an embodiment of the present disclosure;

FIGS. 4-1 and 4-2 are a schematic view illustrating power state aware orchestration of VNF(C)s on P-zones and P-groups in the NFVI according to an embodiment of the present disclosure;

FIG. 5 is a diagram illustrating possible VNFC power profiles according to an embodiment of the present disclosure;

FIG. 6 is a diagram illustrating VNFC power profiles in a VNF descriptor according to an embodiment of the present disclosure;

FIG. 7 is a diagram illustrating NFVI nodes associated to different P-zones (cluster level) according to an embodiment of the present disclosure;

FIG. 8 is a diagram illustrating a compute hierarchy in NFVI according to an embodiment of the present disclosure;

FIG. 9 is a flow diagram illustrating a P-state aware orchestration workflow for VM-based VNFs according to an embodiment of the present disclosure;

FIG. 10 is a flow diagram illustrating a P-state aware orchestration workflow for OS container-based VNFs according to an embodiment of the present disclosure;

FIG. 11 is a diagram illustrating hierarchical policies for power saving on all infrastructure levels according to an embodiment of the present disclosure;

FIG. 12 is a diagram illustrating P-state aware scheduling on vCPUs within an NFVI compute node (dynamic P-zone) according to an embodiment of the present disclosure;

FIG. 13 is a diagram illustrating logical grouping of hardware cores of an octa core CPU based on power characteristics (P-groups) according to an embodiment of the present disclosure;

FIG. 14 is a flow chart illustrating operation of a power state controller changing instantaneous P-state for each core according to an embodiment of the present disclosure;

FIG. 15 is a flow chart illustrating operation of a power state controller changing operating P-state limits for each core according to an embodiment of the present disclosure;

FIGS. 16-1 and 16-2 are a diagram illustrating power state aware orchestration of vRAN applications on appropriate P-zones and P-groups in the O-Cloud according to an embodiment of the present disclosure; and

FIG. 17 is a diagram illustrating P-state aware scheduling of Pods in a Kubernetes® framework according to an embodiment of the present disclosure.

### DETAILED DESCRIPTION

Embodiments of the present disclosure improve and further develop a method and a system of the initially described type in such a way that the energy efficiency and overall power consumption of (large-scale) virtualized environments is optimized.

In accordance with the present disclosure, a method for managing virtual network function components, VNFCs, in a compute infrastructure of a virtualized environment provide the aforementioned improvements and developments. The method includes performing, by an orchestrator system of the virtualized environment, power state-based resource pooling in the compute infrastructure based on CPU power state management policies; and scheduling, by a scheduler, vCPUs of VNFCs on physical cores of appropriate resource pools whose CPU power states match with power profile characteristics of the vCPUs.

Embodiments of the present disclosure provide the aforementioned improvements and developments by a system for managing virtual network function components, VNFCs, in a compute infrastructure of a virtualized environment, the system comprising: an orchestrator system configured to perform power state-based resource pooling in the compute infrastructure based on CPU power state management policies; and a scheduler configured to schedule vCPUs of VNFCs on physical cores of appropriate resource pools whose CPU power states match with power profile characteristics of the vCPUs.

Embodiments of the present disclosure address the overall power saving objective at a global level by the means of workflows, interfaces, systems and methods for power state management in the compute infrastructure for large-scale virtualized environments, such as NFV or vRAN. Embodiments of the present disclosure provide enhancements in the infrastructure design and introduce system and methods for efficient CPU level power state management at runtime according to workload requirements, in an automated fashion.

Embodiments of the present disclosure provide a system and method in the NFVI which can smartly schedule vCPUs belonging to VNFCs on the right physical processors while enabling the NFVI to dynamically adjust P-states of physical processors to save power without conflicting with VNF performance requirements.

According to embodiments, it may be provided that a power state controller controls and dynamically adjusts CPU power states of physical cores of a resource pool at runtime based on real-time utilization metrics. More specifically, it may be provided that CPU power states are dynamically and optimally (with regard to an optimised energy consumption) adjusted at runtime through coordination between infrastructure layer and orchestration layer in a large-scale, virtualized environments/infrastructure with the objective to save power by enabling the management and orchestration system to perform energy-efficient orchestration and power state aware lifecycle management of virtualized heterogeneous workloads, for example, network services and virtual network functions, as well as to implement efficient power management policies.

In an embodiment, the power state-based resource pooling may be performed by dividing compute resources of the compute infrastructure into various power state aware zones, wherein the zones include at least a static P-zone with preset and static power states of the associated compute resources and a dynamic P-zone that allows runtime management of the power states of the associated compute resources.

In an embodiment, the power state-based resource pooling may be performed by further dividing compute resources belonging to a dynamic P-zone into power state-based groups, wherein the groups are based on operating P-state limits of the physical cores of the respective compute resources.

In an embodiment, it may be provided that, for each physical core, CPU power characteristics including operating P-state limits are maintained in a memory component. The CPU power characteristics may be periodically updated to account for runtime dynamic changes. The scheduler may then use the most recent state of the memory component to schedule vCPUs of VNFCs on the physical cores by matching the power profile requirements.

According to embodiments, it may be provided that the power state controller is further configured to either set a P-state for each physical core according to its utilization on a core level, or associate physical cores to their power state-based groups based on workload demand.

In an embodiment, it may be provided that power states from multiple levels of the compute infrastructure hierarchy are exposed at runtime to the orchestrator system of the virtualized environment, wherein the levels include at least one of a core level, node level, cluster level, Point of Presence (PoP) level and cloud instance level.

In an embodiment, it may be provided that the orchestrator system of the virtualized environment uses information about power profile characteristics of the vCPUs provided in the VNF descriptor to perform power state aware orchestration of vCPUs of VNFCs.

According to an embodiment, the system may further comprise a monitoring system configured to obtain data on real-time and historic utilization of compute resources on at least one of a per-cloud/per-cluster/per-node/per-core basis to get power-state signatures associated with different VNFCs. The obtained data may be used as training data for training an artificial intelligence (AI)/Machine Learning (IL) analysis tool to generate power saving policies to be applied at multiple levels in a compute infrastructure hierarchy.

According to an embodiment, the orchestrator system of the virtualized environment may be configured to manage multiple compute infrastructures via a plurality of Points of Presence supporting different virtualisation technologies, such as Openstack, Hyper-V, etc. NFVI-PoPs may also be formed of Kubernetes® clusters supporting containerized deployments.

According to embodiments, the orchestrator system may include a NFV-MANO or a Service and Management Orchestrator, SMO, of an O-RAN, or simply a Kubernetes® based system for management of containerized applications.

In an embodiment, the VNFCs may be components of a containerized virtual network function, VNF, wherein the containerized VNFs are deployed via Containerized Infrastructure Service (CIS) clusters, wherein a CIS manager orchestrates the containerized VNFCs in the form of pods on worker CIS cluster nodes.

The present disclosure provides methods and systems to optimally schedule virtual network function components (e.g., VNFs, O-RAN components, rApps and xApps, etc.) according to their power state requirements in the underlying infrastructure. According to embodiments, the methods and systems may comprise one or more of the following steps/components:
1) Power state-based resource pooling (in terms of zones and groups) in the underlying infrastructure, based on power state management policies, i.e., static or dynamic, and operating power states of compute resources in order to avoid conflicts between power/performance requirements of virtualized workload and power configurations of the underlying hardware.
2) Adjusting power states (e.g. power state controller) in the infrastructure layer to support runtime CPU power state selection at a fine granular level, based on per-core and per-group CPU load utilization for each power state aware compute node in the infrastructure
   a. Autonomous and dynamic power state control for each processor core, adjusting the instantaneous P-state as well as operating P-state limits for each physical core based on runtime demand and CPU utilization.
   b. System of registers and memory blocks on the hardware level or in software form to maintain on-going state for each processor core and assist the scheduler in scheduling vCPUs of virtualized components, e.g., VMs(VNFCs), on the (group of) physical cores in accordance with their power profiles.
3) Power-state aware orchestration algorithms at the orchestration layer (e.g., NFV-MANO and O-RAN SMO), equipped with the information about power profiles for the virtualized workloads, in terms of applicable power management policy and allowed P-states, provided in the (VNF) descriptor for vCPUs of each component (VNFC).

The present disclosure provides methods and systems to dynamically and optimally adjust CPU power states at runtime through coordination between infrastructure layer and orchestration layer in large-scale, virtualized environments/infrastructure with the objective to save power by enabling the management and orchestration system to perform energy-efficient orchestration and power state aware lifecycle management of virtualized heterogeneous workloads, for example, network services and virtual network functions, as well as to implement efficient power management policies. According to embodiments, the methods and systems may comprise one or more of the following steps/components:
1) Division of infrastructure resources into various power zones (P-zones) on a cluster-level based on CPU power state management policies, i.e., static or dynamic management of P-states of the CPU cores.
   a. Logical grouping of physical cores (P-groups), within a compute node, in terms of their operating P-state limits to avoid potential conflicts in the power/performance requirements of heterogeneous virtualized workloads.
   b. Autonomous and dynamic power state control for each processor core using Power State Controller (P-controller), which adjusts the instantaneous P-state as well as operating P-state limits for each physical core based on runtime demand and CPU utilization.
2) Runtime exposure of power states from multiple levels of compute infrastructure hierarchy towards the orchestration layer.

Embodiments of the present disclosure provide at least some of the following advantages:
Address the problem of overall power conservation in a large-scale, federated cloud infrastructure using a centralized, global control, e.g., via MANO in NFV or using SMO in O-RAN.
Solve the problem of conflicting P-state requirements in case of heterogenous virtualized workloads through means of optimal design, pooling, and scheduling of vCPUs.
Dynamic, runtime CPU power state management based on load and demand indicators while considering the global view of the overall system.
Flexible design that can be implemented at the hardware level or in software form by an operating system (OS) or Hypervisor (for both containerized and VM-based network functions).
Fine-granular power state control made available to orchestration layer for power-state aware deployments.
Metrics and telemetry data shared with the orchestration layer to be used for monitoring and policy making.

The advantages offered by virtualization have completely transformed telecommunication networks. The operators are now running their core and RAN functions using technologies such as NFV and vRAN or O-RAN. These, and similar large-scale, virtualized networks can be deployed as an on-premises cloud or on public clouds, such as AWS, GCP, etc. Energy efficiency and optimal power consumption are one of the key challenges that the operators need to tackle in today's large scale, completely virtualized networks.

Generally, there is a need for systems and methods that enable the orchestration layer to perform smart and energy-aware orchestration and lifecycle management of virtualized workloads. Furthermore, in a large-scale, fully functioning, virtualized network deployment, the virtual network functions may have different set of power and performance requirements, depending on the functionality they perform. VNFs or VNFCs, referred to as VNF(C) in this document unless specific mention of a VNF or VNFC is required, with similar power requirements and tolerations can be grouped smartly in the infrastructure. Thus, providing the infrastructure power management functions with more autonomy in adjusting power states of physical compute resources at runtime based on real-time utilization metrics. This would not only avoid conflicting power requirements, but also make the runtime utilization metrics more hygienic and accurate.

Current state of the art systems do not offer much control to the orchestration layer, such as NFV-MANO system, to perform optimal scheduling of VNFCs based on their power state requirements and perform CPU-level power state management in order to conserve overall power consumption within its administrative domain. The NFV framework lacks support for power state aware orchestration performed by the NFV-MANO based on VNF power profiles and their power/performance requirements. The interfaces between the orchestration layer and the infrastructure layer need to communicate the necessary information required for optimal scheduling of VNF components in the NFVI considering the overall objective of power saving. For example, in the case of NFV, the interfaces between MANO entities and NFVI can exchange information on power state-based pools of the underlying compute resources. This information is crucial for the MANO to gain insights into power state management capabilities and policies in the underlying infrastructure, thus enabling MANO to make power state aware NS and VNF deployments.

To make the whole network energy efficient, it is crucial for the operators to have optimal power management policies at both the orchestration layer as well as at the infrastructure layer. The orchestration layer requires information about the power management capabilities offered by the underlying infrastructure at high granularity, so that it can make optimized decisions, considering the objective of power conservation. At the same time, the infrastructure layer needs specific enhancements to enable energy-efficient orchestration and management policies, which is one of the main aspects addressed by embodiments of the present disclosure.

Furthermore, embodiments of the present disclosure propose energy-aware orchestration flows that optimally make use of power management capabilities in the infrastructure while scheduling virtualized network functions and their components, thereby avoiding conflicts in power requirements, and achieving optimal relations between power states and actual workload requirements. This implies coordination between the infrastructure layer and the orchestration layer. For this coordination, embodiments of the present disclosure propose new and extended interfaces that enable an exchange of necessary information related to energy-aware orchestration and exercising optimal power management policies.

Regarding CPU power states, referred to as P-states and C-states herein, the present disclosure adopts standard terminology and concepts from UEFI Forum's ACPI specifications, which specify the following main states that a processor (or a CPU or a CPU core) can be in:
P-states: These are execution performance states in which a processor has the capability of running at different voltage and/or frequency levels, thus incurring various levels of power consumption. These P-states are available while the processor is in the C0 state. Sub-states such as P0, P1, P2, etc. are typically available, being the P0 the highest state resulting in maximum performance, while P1, P2, and so forth, will save power at the penalty of decreasing the processing performance.
C-states: These are power states that a processor can use to reduce power consumption in idle mode, i.e., when no code is being executed. This can be done on a per-core level, or on a CPU package level (by powering down portions of the core package) or both. C0 is an active/operational state where instructions are still executed. The C1 through Cn power states are processing sleeping states in which the processor consumes less power compared to C0.

Current mechanisms to adjust CPU power states (P-states and C-states) do not address the problem of overall power conservation in a large-scale, federated cloud infrastructure using a centralized, global control, e.g., via MANO in NFV or using SMO in O-RAN. These power state management techniques work on the infrastructure level using a local scope. They consist of power state management techniques operating at the hypervisor level or the OS scheduler level. However, they do not consider the problem of conflicting P-state requirements in case of heterogeneous virtualized workloads through means of optimal design, pooling, and scheduling of vCPUs. Some of the existing techniques (see, e.g. US 2018/0210532 A1, U.S. Pat. No. 10,379,904 B2 or US 2021/0096896 A1) rely on guest OSes of VMs to instruct the hypervisor for setting CPU states in the infrastructure without considering requirements of other VMs sharing the same physical resources, thus lacking the global view of the overall system.

To address at least some of these problems, embodiments of the present disclosure provide methods and systems to optimally schedule VNF(C)s according to their power state requirements in the NFVI. According to an embodiment, a NFV-MANO system may be configured to enable maintaining CPU power state-based groups in the underlying compute infrastructure on a per-core level. Based on VNF power profiles available, e.g. in the VNF descriptor (VNFD), the MANO entities, i.e., VNF Manager (VNFM) and Virtual Infrastructure Manager (VIM), may instantiate VNF components on the appropriate (group of) cores in the NFVI according to their power and performance requirements. This kind of energy-efficiency and power state aware orchestration enables optimal, utilization-based P-state adjustments in the physical compute infrastructure, to meet overall power saving objectives.

The teachings of the present disclosure also applies to any other management and orchestration system for virtualized resources, such as Service and Management Orchestrator (SMO) in O-RAN.

Embodiments of the present disclosure enhance the compute infrastructure capabilities in terms of efficient and optimal power management polices of physical compute cores. The orchestration layer can make use of these enhancements to place the virtualized workload on appropriate zones in the infrastructure based on the power state requirements of those components (VNFCs).

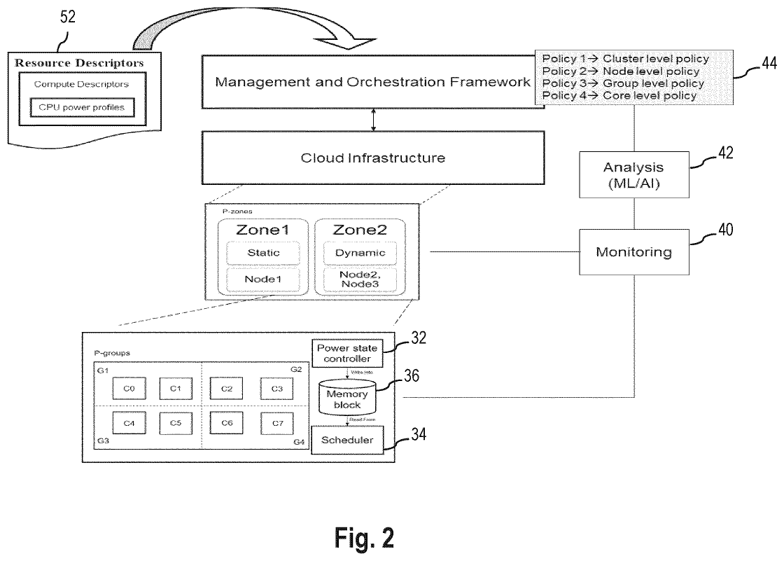

FIG. 2 illustrates how power state-based zones (P-zones) and core groups (P-groups) in the infrastructure layer can be exposed. FIG. 2 captures some of the inventive aspects of the present disclosure, among them the division of infrastructure resources into various P-zones and P-groups to facilitate conflict-free, power state aware orchestration of virtualized workloads (such as VNFs, vRAN Network Functions (NFs), web applications, etc.). The orchestration layer can utilize these power state based capabilities of the infrastructure for better energy management policies, such as power state aware deployment of workloads, controlling energy consumption of the overall network, etc. The concepts of enhanced resource descriptors containing power profiles, P-zones, P-groups, power state controller (P-controller), scheduling of VM's vCPUs or container tasks on the underlying CPU cores are described through different embodiments in the following sections.

### 1. NFV Use Case

To support energy efficient NFV deployments and reduce overall power consumption in the NFV system, the modern VNFs may come with their supported power profiles. These power settings/profiles can come as part of the VNFD. One such case may be to specify the type of CPU power profiles for each VNF/VNF component (VNFC) in the descriptor, provided by the VNF designer. For example, CPU power state management policy, i.e., static or dynamic, as well as allowed P-states for the vCPUs of a VNFC can be described/specified based on its performance requirements. This would allow the NFV-MANO system to dynamically adjust the CPU power states in the underlying physical infrastructure based on per-core utilization to conserve power for specific performance levels.

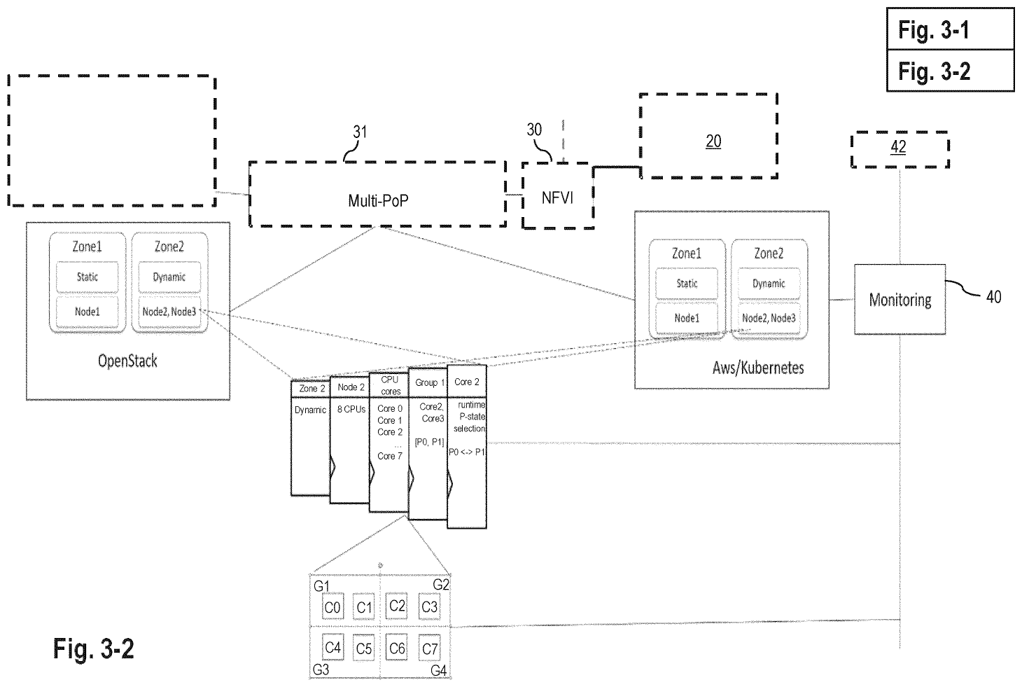

FIG. 4 illustrates, in accordance with an embodiment of the present disclosure, an introduction of power state aware zones (P-zones) and power state based groups (P-groups) in the infrastructure layer (NFVI). This introduction enables the NFV-MANO to place virtualized workloads (VNF(C)s) on the right/appropriate NFVI compute nodes. In an embodiment, the NFV-MANO system may choose the right/appropriate compute node for instantiating the VNF(C) instances based on the required CPU power state management policy, i.e., static or dynamic. Furthermore, the relevant subsystems in the dynamic P-zone that are responsible for adjusting the CPU power states (P-states and C-states), such as a hypervisor, OS kernel etc., can adjust CPU P-states based on runtime CPU utilization, with the objective to conserve power at a more granular level.

For example, the orchestration and management system for NFV use case, the NFV-MANO, through VIM, may maintain power-based zones (P-zones) in the NFVI. FIG. 4 shows a scenario where an NFV-MANO system is managing the resources and workloads running on the infrastructure, i.e., NFVI. P-zones are maintained on a level of cluster or the infrastructure resource group level. P-zones are based on the power management characteristics of underlying compute resources, such as P-state management policies of processor cores within a compute node or a group of compute nodes belonging to a particular zone. The power state management policy for the processor cores can either be ‘static’ or ‘dynamic’. This kind of categorization helps the NFV-MANO system to avoid potential runtime conflicts between the power/performance requirements of heterogeneous workloads, i.e., VNFs, VNFCs. There could be a case where some VNF(C)s are supposed to operate on preset CPU power states (P/C-states) to meet Service Level Agreement (SLA) requirements. These VNF(C)s should be placed in the static P-zone. While on the other hand, there could be some VNF(C)s that support dynamic transitioning of CPU power states for power saving reasons. Those VNF(C)s are placed in the Dynamic P-zone.

According to an embodiment, the NFVI compute resources may, beyond P-zones, further be categorized in power state-based groups (P-groups). P-groups are logical groups of processor cores within the same node/server belonging to a dynamic P-zone. These groups are based on operating P-state limits of cores belonging to Dynamic zone node/server. During runtime, these limits govern the power state controller (as described in detail in section 1.3.2) to adjust P-states of CPU processors dynamically based on CPU utilization. Thus, even the workloads (VNFs/VNFCs) that support dynamic P-states can maintain their SLA requirements by specifying the allowed range of CPU power states in their descriptors (VNFD, for example). The NFV-MANO system may take these VNF power profiles, as described, e.g., in the VNFDs, to make energy-efficient and power state aware orchestration and lifecycle management decisions.

According to embodiments, it may be provided that there are multiple granularity levels of power characteristics on multiple levels of compute hierarchy, from a cloud instance to a PoP, to a node/server, and all the way down to the processor cores.

FIG. 4 shows only one NFVI-PoP 31, however, according to embodiments of the present disclosure can be extended to a multi-PoP environment being managed by one or more VIMs. The NFVI-PoPs can support different virtualization technologies such as Openstack, Hyper-V, etc. NFVI-PoPs may also be formed of Kubernetes clusters supporting containerized deployments.

The NFV-MANO can deploy VNFCs with similar power and performance requirements in the NFVI. Such power state aware deployments can enable the NFVI to conserve energy on core level granularity at runtime in a dynamic, autonomous fashion by adopting a dynamic P-state adjustment policy for each core based on its actual utilization, without conflicting with power and performance requirements of VNFCs. The relevant subsystems in the dynamic P-zone are responsible for adjusting the CPU power states (P-states and C-states), such as a hypervisor, OS kernel, system BIOS, etc. Any of these subsystems can implement the functionality of Power state controller (P-controller). The functions and methods of P-controller are described in section 1.3.2.

A set of orchestration policies on the orchestration level, combined with the energy-aware infrastructure grouping, allows the hypervisor to schedule virtual CPUs (vCPUs) on the right/appropriate physical cores while optimally adjusting the CPU power states in a dynamic, self-autonomous fashion, using a P-controller. The systems and methods introduced in the compute layer, i.e., logical grouping of processor cores (P-groups), dynamic power state control (P-controller) and P-state aware scheduling (Scheduler), in conjunction with the power-state aware orchestration decisions made in the orchestration layer, work in close coordination to achieve the power saving objective for the overall NFV system. The components P-groups, P-controller, and Scheduler are described in detail in section 1.3.

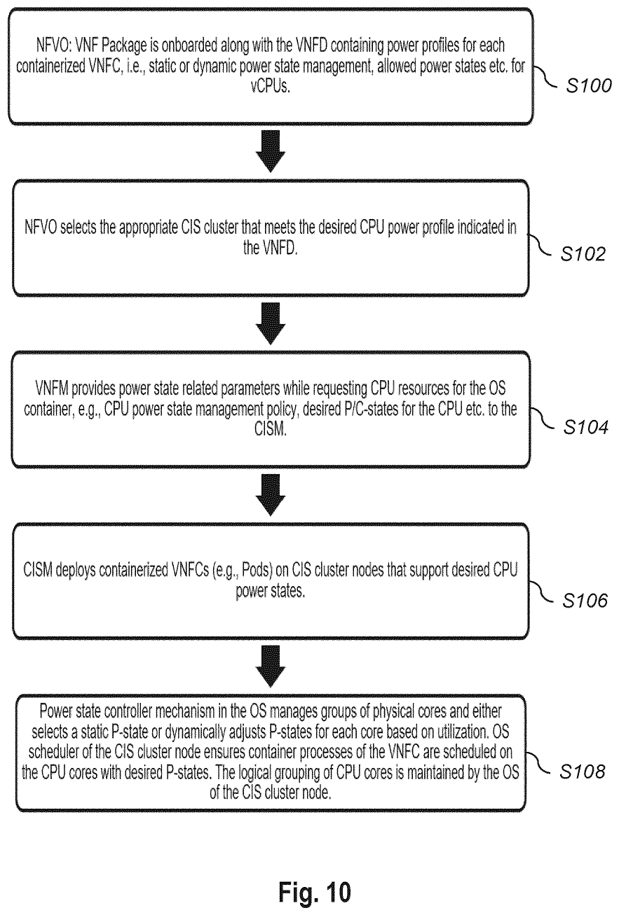

Power state aware orchestration flows such as P-state aware allocation of compute resources for virtualized workloads (VNFs/VNFCs), as illustrated in FIG. 10, at the NFV-MANO can help enable power saving. Furthermore, in an embodiment, there could be energy-efficient lifecycle management policies targeted to save overall power consumption on multiple levels of NFV system.

One example could be a policy related to power consumption in an NFVI-PoP. If the power consumption is above a certain threshold, then new NS/VNF(C) instances may be deployed to an alternate NFVI-PoP. Alternatively, if an NFVI-PoP, say NFVI-PoP #1, is underutilized and the running instances can be migrated elsewhere, say to NFVI-PoP #2, if migration would not violate power consumption thresholds of NFVI-PoP #2. Having an overall global view and fine-grained power characteristics are crucial for such kind of NS/VNF migration to maintain SLAs and power/performance requirements of an NS/VNF.

FIG. 2 illustrates the overall system level concept of power state aware orchestration of virtualized workloads. The fine-grained control of power characteristics in different levels of compute hierarchy, i.e., at core level, node level, cluster level, PoP level, cloud instance level, etc. enables the orchestration and management systems, such as MANO, to implement energy efficient orchestration and lifecycle management policies.

Hereinafter, in accordance with embodiments of the present disclosure, three aspects regarding the placement of VNFCs on the underlying infrastructure are described in detail:
1) Orchestration and instantiation (taken care of by NFV-MANO)
2) Scheduling of vCPUs belonging to VNFCs on physical CPU cores (taken care of by the Hypervisor or Virtual Machine Manager (VMM), or Host OS in case of containerized VNFs)
3) Monitoring overall power characteristics of the infrastructure and performing analysis for designing energy-efficient strategies and policies.

1.2 Orchestration and instantiation

Hereinafter, in accordance with embodiments of the present disclosure, four aspects to the power state aware orchestration and instantiation of VNF components in the NFVI are described:
Power profiles in the VNF descriptors
Power state-based zones in the NFVI
Information exchange on interfaces between NFV-MANO and NFVI
Orchestration workflows in the NFV-MANO and power management policies on different hierarchical compute levels in the NFVI
   1.2.1 Power profiles in the VNFD

The VNFD can include ‘Power Profiles’ specifying the type of CPU power state management policy for itself or its constituent VNFCs vCPUs, i.e., static or dynamic. Furthermore, in the case of dynamic P-state adjustments, allowed P-state levels may also be included in the descriptor as part of these power profiles. Pre-set values of P-states and C-states for VNF(C)'s vCPU(s) can be specified for static scenario. The NFV-MANO and Hypervisor would consider these power profiles while instantiating the VNFCs and other lifecycle management operations, e.g. scaling, as well as managing power states (P-states and C-states) of physical CPUs at runtime according to the limits advertised in the descriptor.

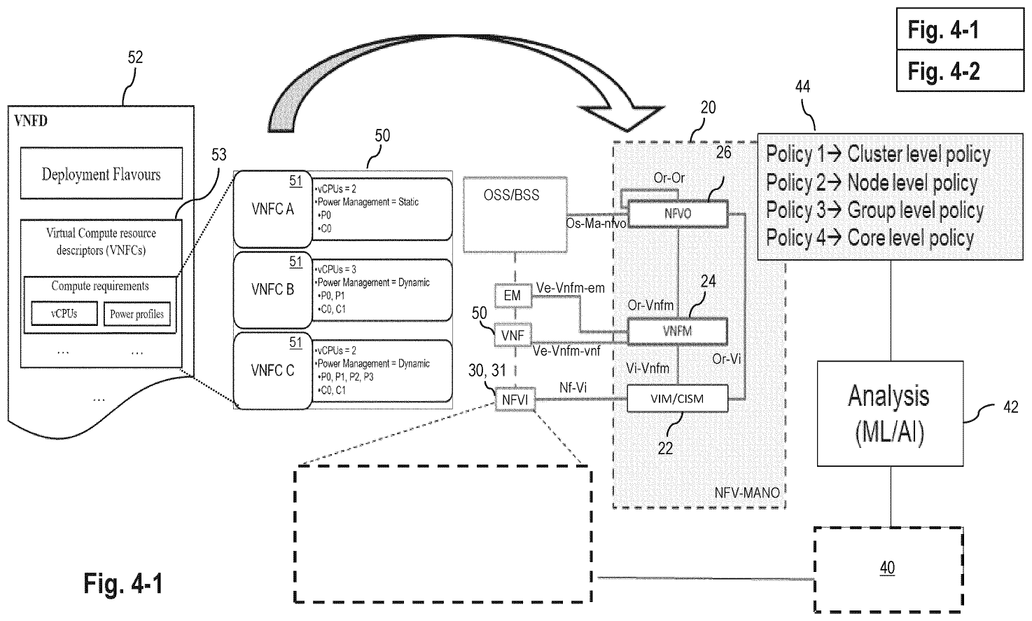

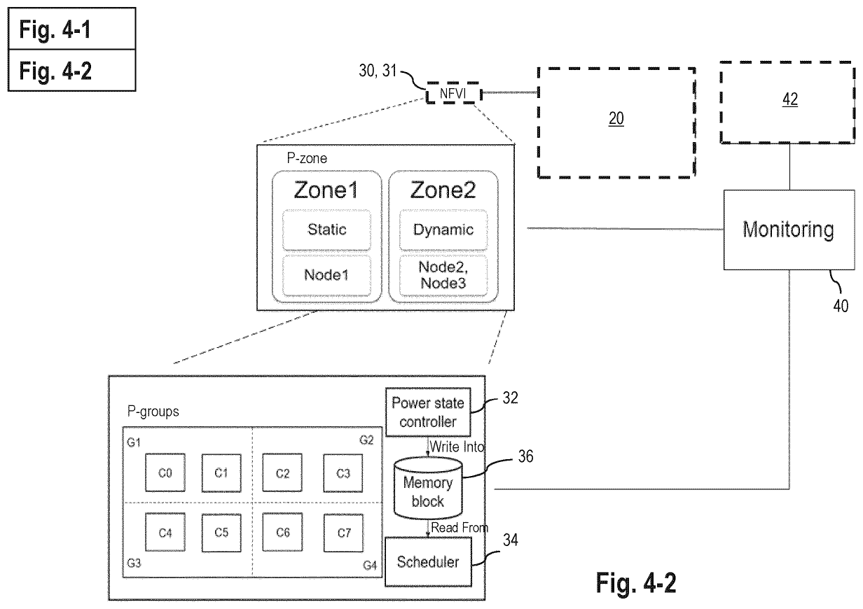

FIGS. 5 and 6 show an example of VNF power profiles for each component 51 of a VNF. While FIG. 5 provides just an overview of the placement of the compute resources of the respective VNFC 51 and power state operation of its vCPU(s), FIG. 6 provides some additional details, including the provision of the respective information within the VNF descriptor 52.

In the illustrated embodiment, according to the descriptor 52 the VNFC A 51A is placed on the compute resources in the static P-zone and requires its vCPU(s) to operate in P0, i.e., the highest power consuming state. This requirement shall be considered by the orchestrator during instantiation and the Hypervisor for scheduling of vCPUs on underlying physical cores throughout the lifecycle of this VNFC.

In this case, the VNFC A 51A is placed on the compute resources in the Static P-zone. According to embodiments, the NFV-MANO subsystems (Network Functions Virtualisation Orchestrator, NFVO, Virtualised Network Function Manager, VNFM, Virtualised Infrastructure Manager, VIM and Containerised Infrastructure Service Manager, CISM) may be configured to consider these power characteristics while allocating compute resources for VNFC A 51A. The NFVI subsystem in the compute layer may be configured to maintain the P-state of the underlying processor cores in P0, meeting the power/performance requirements of VNFC A 51A. Thus, the power state of the core(s) serving VNFC A 51A remains the same (static) throughout the lifecycle of VNFC A 51A.

The VNFC B 51B on the other hand is placed on the dynamic P-zone and its vCPU(s) can be operated in P0 or P1. The VNFC C 51C, which is also placed on the dynamic P-zone, gives the MANO and the Hypervisor or the Host OS the freedom to adjust P-states of its vCPUs within a pre-set power-state range of P0, P1, P2, P3. This can help the hardware power management controller to put the physical CPU cores in deeper P states if CPU utilization is low, thereby saving power. Enhancements in the hardware/hypervisor/OS layer are necessary to support this kind of dynamic, autonomous power state management on a per-core level, which are discussed later in this specification.

As can be obtained from FIG. 6, the virtual compute resource descriptors 53 of the VNFD 52 may contain additional information of how many vCPUs are required for processing a particular VNCF (2 for VNFC A and VNFC C, respectively, and 3 for VNFC B in the illustrated embodiment) and additional information about the possible power states (C0 for VNFC A and C0, C1 for VNFC B and VNFC C, respectively, in the illustrated embodiment).

Within NFVI, a VNF can be deployed using VMs or OS containers. For containerized VNFs, compute characteristics and power profile for CPUs can be provided using the VNFD same way as VM-based VNFs. Containerized Infrastructure Service (CIS) clusters are used for deploying containerized VNFs. One example of such Containerized Infrastructure Service is Kubernetes®. A Containerized Infrastructure Service Manager (CISM), such as a Kubernetes® control plane, is used to manage CIS (Container Infrastructure Service) cluster resources and is responsible for orchestrating containerized VNFCs, for example in the form of a Kubernetes® pod on worker CIS cluster nodes.

### 1.2.2 Power State-Based Zones in the NFVI

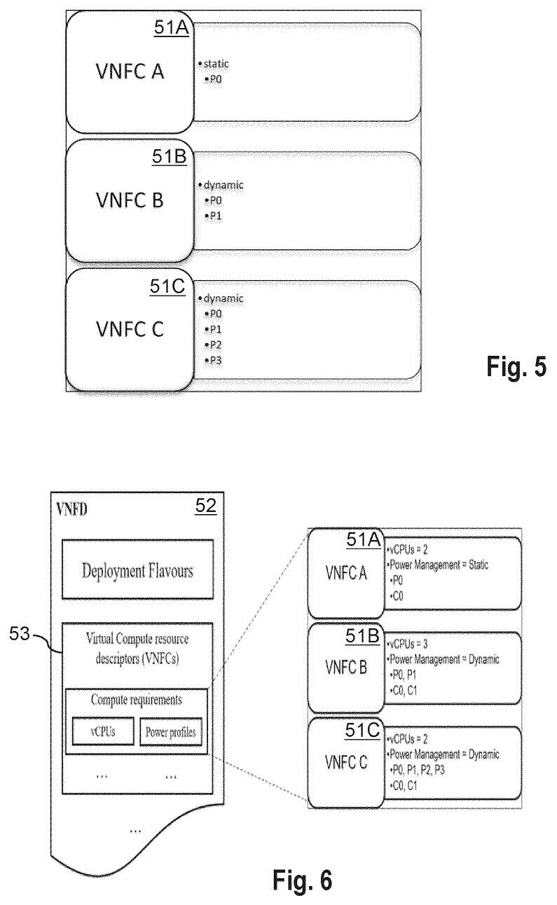

According to embodiments of the present disclosure, power state-based zoning in the NFVI compute hierarchy is used to enable the orchestration layer for introducing energy-efficient orchestration and smart, dynamic and autonomous power state management of compute infrastructure considering the objective of reducing power consumption in the overall system. FIG. 7 shows an embodiment of how NFVI compute nodes can be associated to the specific power-state zone (P-Zone) based on the kind of power management policies being followed on those compute nodes, i.e., static or dynamic. Static power management refers to power state management of CPU cores that the vCPUs of a VNFC are scheduled on. This scenario allows the VNF designer or the operator to set custom power and performance requirements for the vCPUs of VNF(C)s to save power. In this scenario, the CPU power states are not changed during the lifecycle of those VNFCs. Thereby, a zone in the NFVI with statically managed power states is needed for deploying such VNFs.

On the other hand, dynamic zones allow the runtime management of the power states, i.e., P-states of the CPU cores to be adjusted dynamically based on CPU utilization. This kind of dynamic adjustment of P-states in the infrastructure, in conjunction with the policies on the orchestration layer (such as, P-state aware allocation of compute resources for VNF(C) LCM operations such as, instantiation, scaling, etc.), achieve a two-fold objective of saving power consumption at runtime during lifecycle of virtualized workloads and avoiding power requirements conflicts among virtual components sharing the same physical hardware.

According to embodiments of the present disclosure, these NFVI zones may initially be maintained by VIM or CISM based on the workload requirements coming from the orchestration layer (e.g., NFVO and VNFM) and may later be managed dynamically by VIM or CISM based on actual demand.

According to embodiments of the present disclosure, CISM may manage the zoning of CIS cluster nodes and their CPU power profiles based on workload demand.

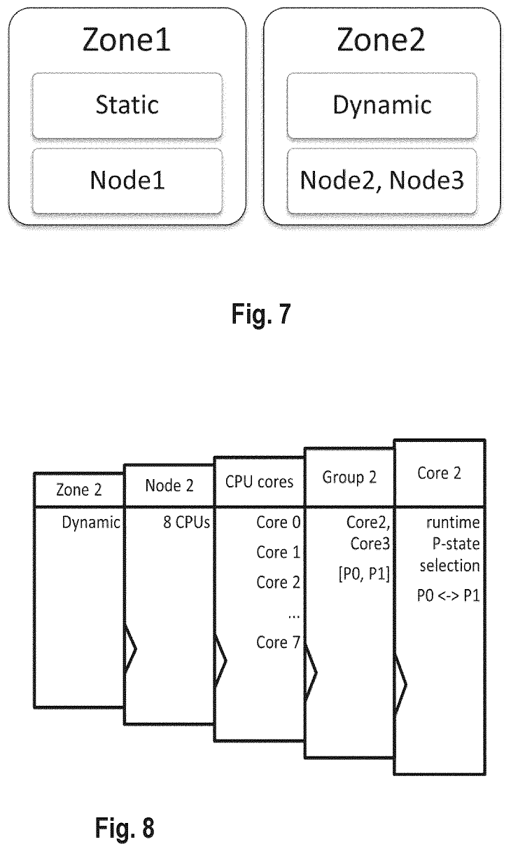

FIG. 8 illustrates an embodiment of the present disclosure, according to which a further breakdown of compute resources in the NFVI is realized. Specifically, FIG. 8 illustrates an association of P-states per core. CPU cores within a compute node can be grouped together according to their allowed P-state ranges. The power state controller within each compute node can adjust P-states of cores based on their actual utilization while considering the allowed range. These groupings are not preset and can change dynamically based on demand. This logical grouping (P-groups) are further explained in section 1.3.1.

### 1.2.3 Information Exchange on the Interfaces Between NFV-MANO and NFVI

In ETSI NFV, the virtualized infrastructure manager (VIM) manages the virtualized resources (compute, storage, network) in the underlying NFV infrastructure (NFVI). While orchestrating Network Services (NS) and associated Virtual Network Functions (VNFs), the NFVO and VNFM interact with the VIM for the allocation of virtualized compute resources in the NFVI. The interactions take place between the MANO entities on the following reference points, as also illustrated in FIG. 4:
Or-Vnfm reference point (between NFVO and VNFM)
Vi-Vnfm reference point (between VNFM and VIM)
Or-Vi reference point (between NFVO-VIM)

The abovementioned reference points are specified in relevant ETSI NFV specifications, e.g., ETSI GS NFV-IFA 005 (https://www.etsi.org/deliver/etsi_gs/NFV-IFA/001_099/005/04.05.01_60/gs_NFV-IFA005v040501p.pdf), ETSI GS NFV-IFA 006 (https://www.etsi.org/deliver/etsi_gs/NFV-IFA/001_099/005/04.05.01_60/gs_NFV-IFA005v040501p.pdf) and ETSI GS NFV-IFA 007 (https://www.etsi.org/deliver/etsi_gs/NFV-IFA/001_099/007/04.05.01_60/gs_NFV-IFA007v040501p.pdf), which are hereby incorporated herein by reference.

Operations related to the allocation of compute resources are executed via VIM exposed interfaces on the Or-Vi and Vi-Vnfm reference points, such as interfaces related to Virtualised Compute Resource Management and Virtualised Resource Reservation Management. Both NFVO and VNFM can allocate virtualized compute resources via VIM depending on different workflows supported within NFV-MANO standard framework.

According to embodiments of the present disclosure, in order to enable power state aware orchestration of VNF(C)s and facilitate coordination between the orchestration layer and infrastructure layer, additional information may be exchanged between the entities related to power characteristics of VNFs that need to be deployed.

For power state aware orchestration of containerized VNFs, NFV-MANO selects the appropriate CIS cluster that meets the desired CPU power profile indicated in the VNFD. Supported CPU profiles can be advertised using CIS cluster node tags. Furthermore, VNFM may provide power state related parameters while requesting CPU resources for the OS container, e.g., CPU states management policy, desired P/C-states for the CPU etc. to the CISM. CISM is then expected to deploy the containerized VNFCs on CIS cluster nodes that support desired CPU power states.

Compute parameters may be exchanged over the compute management interfaces exposed by CISM towards NFV-MANO, namely ‘OS container compute management service interface’, as specified in ETSI GS NFV-IFA 040 titled, “Network Functions Virtualisation (NFV) Release 4; Management and Orchestration; Requirements for service interfaces and object model for OS container management and orchestration specification” (https://www.etsi.org/deliver/etsi_gs/NFV-JFA/001_099/040/04.05.01_60/gs NFV-IFA040v040501p.pdf.)

The following Table 1 provides a non-exhaustive list of parameters related to each VNF component that can be provided to VTM and/or CISM for power-state aware orchestration while allocating compute resources during instantiation and scaling operations.

TABLE 1
Parameter list for information exchange on standard interfaces

| | | | | | Interfaces |
|---|---|---|---|---|---|
| | | | | | (non- |
| | | | | | exhaustive |
| Parameter | Cardinality | Type | Description | Operation | list) |
| powerState | 1 | ENUM | Describes the power | Compute | Virtualised |
| ManagementPolicy | | | state management | allocation, | Compute |
| | | | policy applicable for | Instantiation, | Resource |
| | | | the VNFC. | Scaling | Management |
| | | | Possible values: | | Interface |
| | | | STATIC | | OS container |
| | | | DYNAMIC | | compute |
| | | | | | management |
| | | | | | service |
| | | | | | interface |
| vCpuPower | 0 . . . N | KeyValue | Contains power | Compute | Virtualised |
| Profile | | Pair | profiles for all vCPUs | allocation, | Compute |
| | | | of the VNF | Instantiation, | Resource |
| | | | component in terms of | Scaling | Management |
| | | | allowed P-states and | | Interface |
| | | | optionally C-states | | OS container |
| | | | that the vCPU should | | compute |
| | | | operate in. | | management |
| | | | Shall be present if | | service |
| | | | powerStateManagmentPolicy | | interface |
| | | | attribute is set | | |
| | | | to DYNAMIC. | | |

It should be noted that the above Table 1 does not provide an exhaustive set of parameters. According to alternative embodiments, there may be additional attributes and parameters that may be added to comply with other aspects of orchestration and resource allocation in NFV. The parameters mentioned in Table 1 can be used for power-state aware LCM operations such as instantiation, scaling, etc. for VNFs over NFV-MANO reference points, Or-Vi, Vi-Vnfm and Or-Vnfm between different NFV-MANO entities. These applicable reference points are illustrated in FIG. 4.

According to an embodiment, the VIM may use the provided information to design P-state based groups of processor cores in one or multiple compute nodes. Logical grouping (P-groups) of cores within a compute node based on their P-state characteristics are described in section 1.3.1.

The VIM has a holistic view of the NFVI PoPs under its administrative domain and the configuration of power state-based zones (P-zones), compute nodes, and further core-level groups (P-groups) within each compute node. The orchestrators, such as NFVO, can get this information from VIM via polling or subscription/notification mechanism and can thereby obtain an holistic view of power consumption in the whole network.

### 1.2.4 Orchestration Workflows and Power Management Policies

According to embodiments of the present disclosure, new workflows may be implemented to support power state aware orchestration in the NFV-MANO. Furthermore, a set of power management policies may be implemented to operate on all hierarchical levels of compute infrastructure, i.e., core level/compute node level/zone level/NFVI-PoP level and so on (see FIG. 8). The power management policies may help decrease overall power consumption in the system, benefiting from the global view of the system that MANO possesses.

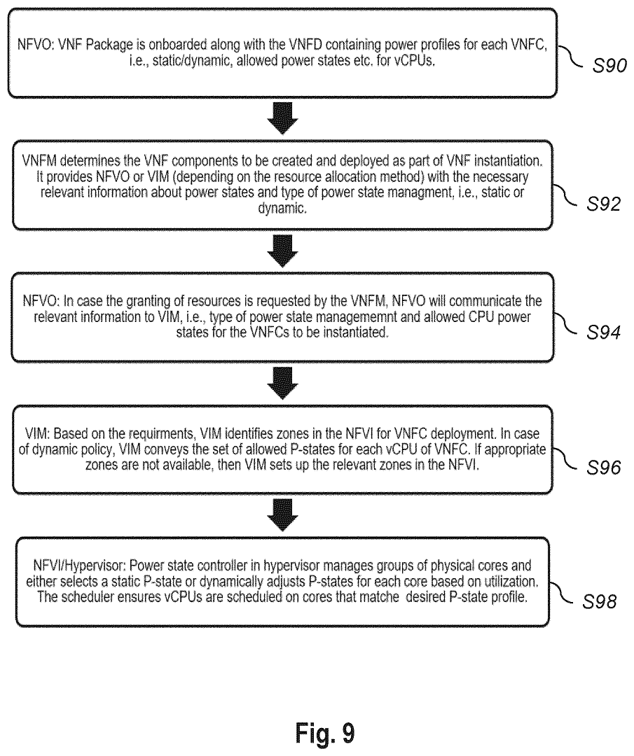

An embodiment of a basic power aware orchestration workflow for instantiation of VM-based VNFs is shown in FIG. 9. The NFV-MANO entities with the help of VNFD and necessary information exchanges over the interfaces make sure to instantiate the components in the right zone with the right power-state profiles.

As shown that step S90, the orchestration starts at the NFVO when a VNF package is onboarded along the VNFD containing power profiles for each VNFC, i.e., static or dynamic, allowed power states, etc. for vCPUs. First, as shown at step S92, the VNFM may determine the VNF components to be created and deployed as part of the VNF instantiation. Then, the VNFM provides NFVO or VIM (depending on the utilized resource allocation method) relevant information about power states and type of power state management, i.e., static or dynamic. In case the granting of resources is requested by the VNFM, the NFVO may communicate the relevant information to the VIM, i.e., the type of power state management and CPU power states for the VNFCs to be instantiated, as shown at step S94.

As shown at step S96, based on the received information about the requirements, the VIM may identify zones in the NFVI for VNFC deployment. In case of dynamic policies, the VIM may convey the set of allowed P-states for each vCPU of VNFC. If appropriate zones are not available, the VIM may set up the relevant zones in the NFVI.

Finally, as shown at step S98, the power state controller may manage groups of physical cores and either select a static P-state or dynamically adjust P-states for each core based on utilization. The scheduler may be configured to ensure that vCPUs are scheduled on cores that match the desired P-state profile.

Similarly, FIG. 10 shows an embodiment of an orchestration workflow for containerized VNFs. Again, the orchestration starts at the NFVO when a VNF package is onboarded along the VNFD containing power profiles for each VNFC, i.e., static or dynamic, allowed power states, etc. for vCPUs, as shown at step S100. First, as shown that step S102, the NFVO selects an appropriate CIS cluster that meets the desired target CPU power profile indicated in the VNFD.

Next, the VNFM may provide power state related parameters while requesting CPU resources for the OS container (step S104) to the CISM. These parameters may include, e.g., CPU power state management policy, desired P/C-states for the CPU, etc. Accordingly, the CISM may deploy containerized VNFCs (e.g., Pods) on CIS cluster nodes that support the desired CPU power states (step S106).

Finally, as shown at step S108, the power state controller mechanism in the OS may manage groups of physical cores and either select a static P-state or dynamically adjust P-states for each core based on utilization. The OS scheduler of the CIS cluster node may be configured to ensure that container processes of the VNFC are scheduled on CPU cores with the desired P-states. In this context, it may be provided that the OS of the CIS cluster node is configured to maintain the logical grouping of CPU cores.

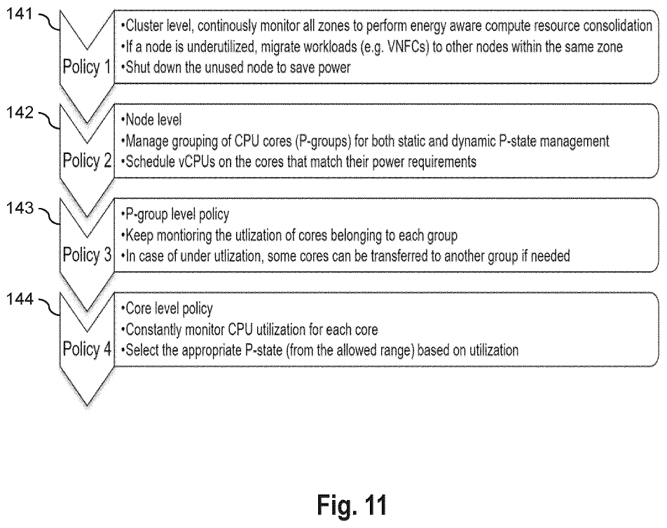

Dynamic power saving policies operating at multiple levels of the compute infrastructure hierarchy provides means to reduce power consumption in the overall system. An example of such hierarchical policies is shown in FIG. 11. It should be noted that the top-down approach shown in FIG. 11 is made possible by the provision of power state management mechanisms at all levels of granularity (from infrastructure cluster to a physical/logical core) and coordination between all levels of infrastructure.

According to the illustrated embodiment, a first policy 141 may be implemented on cluster level. According to this policy 141, a continuous monitoring of all zones may be provided to enable energy aware compute resource consolidation. For instance, if a node is underutilized, workloads (e.g., VNFCs) may be migrated to other nodes within the same zone. Furthermore, according to cluster level policy 141 unused nodes may be shut down to save power.

Another policy 142 may be implemented on node level. For example, this policy 142 may manage grouping of CPU cores (P-groups) for both static and dynamic P-state management. Furthermore, policy 142 may schedule vCPUs on the cores that match their power requirements.

Yet another policy 143 may be implemented on P-group level. For example, according to this policy 143, it may be provided to keep monitoring the utilization of cores belonging to each group. In case of underutilization, some cores may be transferred to another group if needed.

Yet another policy 144 may be implemented on core level. For example, according to this policy 144, CPU utilization may be constantly monitored for each core and, based on utilization, the appropriate P-state may be selected (from the allowed range).

According to embodiments of the present disclosure, different power state aware orchestration algorithms may be implemented at the orchestration layer (for instance, NFV-MANO and O-RAN as illustrated in FIG. 4). The orchestration layer may be provided with the information about power profiles for the virtualized workloads in terms of applicable power management policies and allowed P-states, provided in the (VNF) descriptor for vCPUs of each component (VNFC). For instance, with reference to FIG. 4, the orchestration flow may be presented as follows:
Step 1: A VNF Package 50 is onboarded along with the VNFD 52 containing power profiles for each VNFC 51 (static/dynamic, allowed power states etc. for vCPUs).
Step 2: An orchestrator system, NFV-MANO 20 in FIG. 4, uses the power profile information to place the VNF(C) 51. Specifically, the orchestrator system determines the zone within the NFVI 30 where to deploy the VNF(C) 51. If an appropriate zone is not available, a relevant subsystem (for example, VIM 22) may be configured to create the zone.
Step 3: VNFM 24 determines the components to be created and deployed as part of VNF instantiation. It provides NFVO 26 or VIM 22 (depending on the resource allocation method) with the necessary relevant information about power states and type of power state management, i.e., static or dynamic.
Step 3b: In case of containerized VNFs, NFVO 26 may be configured to select an appropriate CIS cluster that meets the desired CPU power profile indicated in the VNFD 52.
Step 4: NFVO 26: In case the granting of resources is requested by the VNFM 24, NFVO 26 will communicate the relevant information, including, e.g., type of power state management and allowed power states for the VNFCs 51 to be instantiated to VIM 22.
Step 4b: In case of containerized VNFs, VNFM 24 provides power state related parameters while requesting CPU resources for the OS container, e.g., CPU states management policy, desired P/C-states for the CPU, etc. to the CISM.
Step 5: VIM 22: Based on the requirements, VIM 22 identifies zones in the NFVI 30 for VNFC 51 deployment. In case of dynamic policy, VIM 22 may be configured to convey the set of allowed P-states for each vCPU of VNFC 51.
Step 5b: CISM deploys containerized VNFCs (e.g., Pods) on CIS cluster nodes that support desired CPU power states.
Step 6: NFVI 30/Hypervisor: Power state controller 32 manages groups of physical cores and either selects a static P-state or dynamically adjusts P-states for each core based on utilization. Scheduler 34 ensures vCPUs are scheduled on the core that matches desired P-state profile.
Step 6b: CIS cluster node: A power state controller mechanism in the OS manages groups of physical cores and either selects a static P-state or dynamically adjusts P-states for each core based on utilization. An OS scheduler of the CIS cluster node may ensure container processes of the VNFC are scheduled on the CPU cores with desired P-states. The logical grouping of CPU cores is maintained by the OS of the CIS cluster node.
Step 7: P-state information will be monitored by a monitoring system 40, collected and transferred as an input for AI/ML analysis tool 42 to generate (multi-level) policies 44.
Step 8: Policies 44 generated in Step 7 will be applied by the orchestrator system 20 to save energy.

The power state management systems and methods introduced in the following sections offer optimal grouping of processor cores and power state management of CPUs on a per-core basis, enabling the whole system to save power in an efficient way, while avoiding conflicts between power and performance requirements of running workloads.

1.3 Scheduling of vCPUs Belonging to VNFCs on Physical CPU Cores

There is a need for systems and methods operating at the infrastructure layer to equip the NFV-MANO for meeting the overall objective of reducing power consumption in the whole NFV system and to facilitate power-state aware orchestration and lifecycle management of VNFs. According to embodiments of the present disclosure, this is achieved using the following:
P-groups: Logically grouping the processing cores of the compute node based on allowed operating levels of CPU P-states;
A power state controller (P-controller) configured to manage the P-states of each core at runtime based on measured CPU utilization; and/or
A scheduler configured to schedule vCPUs on the physical cores in accordance with their desired operating P-states.

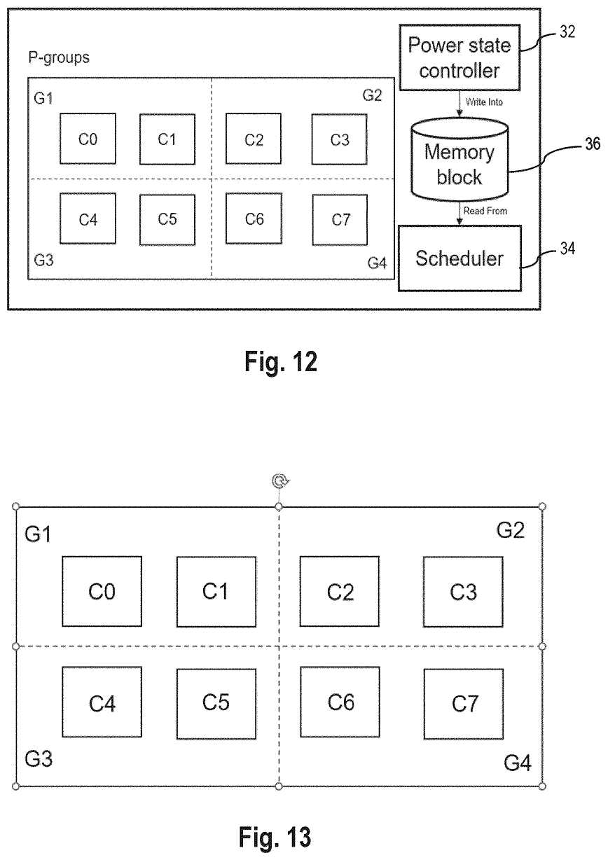

FIG. 12 schematically illustrates P-state aware scheduling of vCPUs within an NFVI compute node (Dynamic P-zone) according to an embodiment of the present disclosure. The components shown in FIG. 12 work together, in close coordination, toward the objective of running the CPUs in the power states that are according to their actual runtime load, thereby avoiding wastage. The power state controller manages P-groups at runtime, based on demand. The CPU power characteristics, such as operating P-state limits, are maintained in a memory block for each compute core and are updated periodically due to runtime dynamic changes. The scheduler uses the latest memory state while scheduling vCPUs of VNFCs on the underlying physical CPU cores by matching the power profile requirements. More technical detail of operations performed by these components are described in the following sections.

It is noted that the components responsible for logical grouping, power state control and vCPU scheduling are technology independent. They can be either managed by the Hypervisor (in case of VMs), an operating system (in case of OS containers) or purely at the bare metal (hardware) level through BIOS and hardware state registers. It goes without saying that the illustration shown in FIG. 12 is just one embodiment of the three logical components, i.e., P-groups, power state controller and scheduler. They can be implemented in different ways and using different technological means, such as a subsystem in the Hypervisor or an OS function, etc.

### 1.3.1 Logical Grouping of Cores

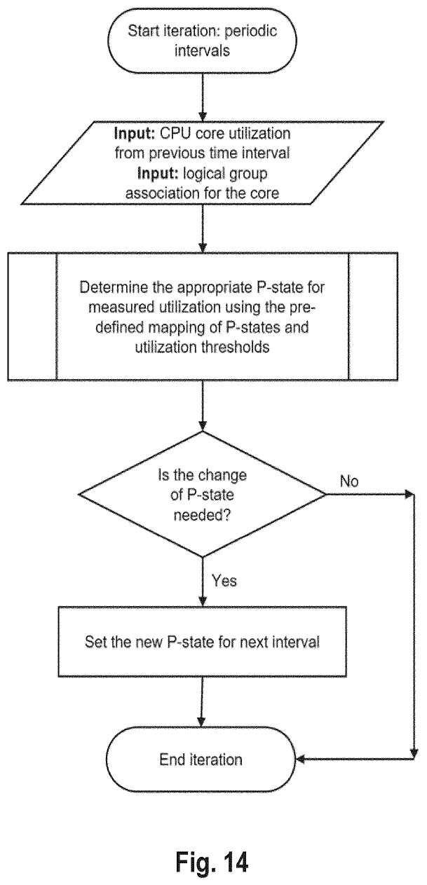

Physical cores of the CPU are logically grouped together based on operating P-state levels for the core(s). These P-groups facilitate dynamic and autonomous P-state adjustments made by the power state controller for each core, depending on its load. For example, if a core's utilization is low, then it can be put into a low performance state to save power. One illustration of such logical grouping is shown in FIG. 13. The groups G1, . . . , G4 have two cores each with varying limits of allowed CPU P-states, described in Table 2.

TABLE 2
Mapping between (group of) cores and
their operating P-state ranges

| Logical | | | |
|---|---|---|---|
| Group | Cores | Operating P-states | Utilization thresholds (examples) |
| G1 | C0, C1 | P0 | N/A |
| G2 | C2, C3 | P0, P1 | 100-50%, 50-0% |
| G3 | C4, C5 | P1, P2, P3 | 100-70%, 70-40%, 40-0% |
| G4 | C6, C7 | P0, P1, P2 . . . | 100-90%, 90-80%, 80-70% . . . |

The processor shown in FIGS. 12 and 13 has eight cores which can be assigned to one of the logical groups. A group has a pre-set range of allowed P-states that its cores can operate in. Power state controller sets the P-states of each core from the allowed range by monitoring core utilization in a given time interval. Core utilization thresholds can be defined against the allowed P-states for each set.

It is noted that the processor configuration illustrated in FIGS. 12 and 13 and Table 2 is just for example and that there can be numerous variations of logical grouping and permutations of allowed P-states and their corresponding utilization thresholds.

Further, it is noted that the grouping is flexible and dynamic and can be adjusted based on demand. According to embodiments, the cores may be moved between groups if needed. This adjustment can either be governed by MANO based on workload scheduling demands, or the power state controller in the hypervisor may be configured to move the cores based on groups (for instance, see Policy #3 in FIG. 11). For example, in the scenario described in FIG. 13 and Table 2, if group utilization of G4 is constantly low, while G3 records high utilization, C7 can be associated with G3.

Such kind of logical grouping of processor cores, as exemplarily depicted in Table 2, maintained by either the VMM (Hypervisor), OS, or at bare metal (hardware) level can not only avoid scheduling conflicts between heterogeneous workloads with different power state requirements but also decreases performance overhead of switching the CPU P-states too often when VNFCs with largely varying power and performance requirements are sharing the same physical resources.

There could be a case for a very small-scale infrastructure with only one compute node. In that case, there could be multiple P-zones (static, dynamic) maintained within the same node. For example, in the same node, there could be two zones (P-zones): a static zone for workloads that require preset and static management of CPU power states, and a dynamic zone for workloads that allow dynamic adjustment of CPU power states. For example, taking FIG. 13 with 8 CPU cores, 4 of them could be assigned to static P-zone, the other 4 to dynamic P-zone. Furthermore, the dynamic zone could have one of multiple P-groups, i.e., logical grouping of the four remaining cores into different operating P-state limits, as described in Table 2. Therefore, the P-zones introduced in section 1.2.2, are also logical and can be implemented at different levels of granularity/hierarchy.

The orchestrator layer components, such as VIM (or CISM) in NFV-MANO, can have access to the information about P-groups within the NFVI compute node through periodic polling or subscription/notification mechanism for better planning regarding infrastructure management and placement of virtualized (or containerized) workloads. This way, for instance, according to an embodiment, the VIM/CISM may demand the infrastructure layer for creation of new P-groups for new workloads based on the power/performance requirements specified in their respective descriptors.

According to another embodiment, the implementation could be to maintain state of P-groups (cf. Table 2) at the infrastructure manager layer (i.e., VIM, CISM or Kubernetes® master node).

### 1.3.2 Power State Controller

The power state controller is one of main components operating at the compute node and may be responsible for setting P-states of the CPU cores, e.g. as per their measured utilizations in a given time interval. This interval as well as the utilization thresholds against specific P-states are configurable entities.

The power state controller may have two main operations and may be responsible for managing two crucial attributes for each CPU core at runtime. These main operations may include:
1. Setting P-state for each CPU core according to its utilization (on a core level)
   In this context, the controller may use CPU load measurements and ‘utilization threshold to P-state’ mapping as input for this operation
2. Associating cores to their logical groups based on workload demand
   In this context, the controller may use the combined utilization of each group to assess if a certain group is over-stressed. This way it can assign a core from under-utilized group to the stressed group, if feasible. This high utilization may be due to the fact that the Scheduler is constantly scheduling vCPUs on the cores belonging to that group, indicating high scheduling demand of VNFCs with the matching power profile.

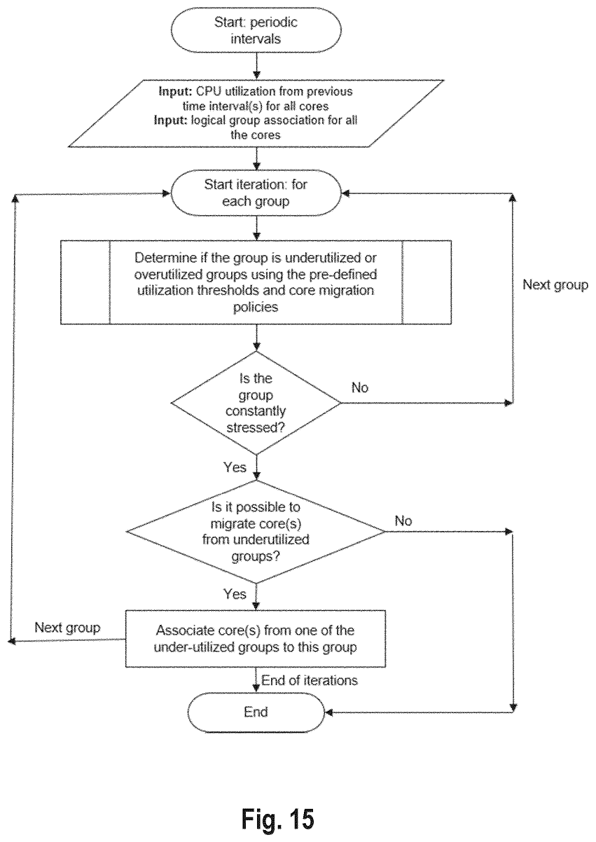

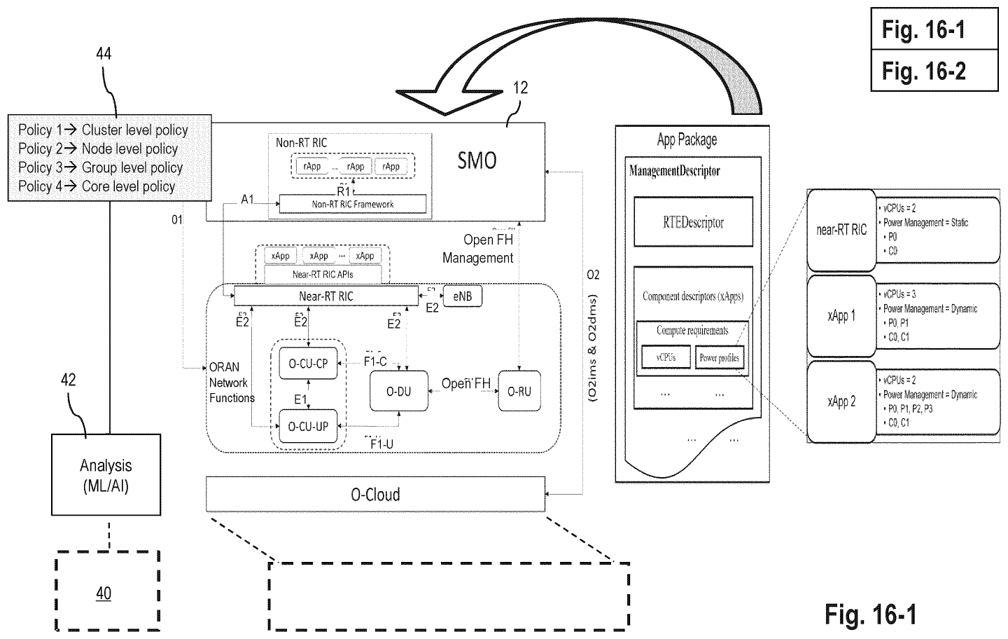

FIG. 14 shows a workflow of an embodiment according to the above operation #1, while FIG. 15 shows a workflow of an embodiment according to the above operation #2.

In operation #1, the power state controller sets the instantaneous P-state for each core according to the operating limits defined by its associated group.

In operation #2, the power state controller also manages group associations for each core. This way the logical mapping of cores into groups can be changed on the basis of per-group utilization. If the controller senses a particular group being over-utilized over some period of time, it can move around group boundaries by associating more cores (from one of the under-utilized groups) to the stressed group.

According to embodiments, the power state control mechanisms (operation #1 and operation #2) may be performed by a subsystem in NFVI, a VMM (Hypervisor), an OS or at bare metal (hardware) level.

### 1.3.3 Scheduler

The scheduler is the component that schedules vCPUs of VNFCs on the underlying physical CPU cores by matching the power profile requirements.

It is noted that the core's group association, i.e., its operating P-state limits, may dynamically change at runtime due to operation #2 (cf. FIG. 15) of the power state controller. Therefore, the scheduler must have up-to-date information on a physical core's instantaneous power state settings. According to an embodiment, this may be done by a shared memory block shared between the power state controller and the scheduler. The controller can periodically write per-core power settings information in the memory block and the scheduler can read from the memory block to get the information for scheduling purposes. Time-blocking mechanisms or optimal time interval configurations can be used to avoid conflicts arising from race conditions. As an example, one embodiment of this memory block is shown in Table 3.

TABLE 3
Per-core runtime group associations and their current P-state info

| Cores | Group associations | Operating P-states | Current p-state |
|---|---|---|---|
| C0 | G1 | P0 | P0 |
| C1 | G1 | P0 | P0 |
| C2 | G2 | P0, P1 | P1 |
| C3 | G2 | P0, P1 | P0 |
| C4 | G3 | P1, P2, P3 | P2 |
| . . . | . . . | | |
| . . . | . . . | | |

For example, if an instance of VNFC B (see example VNFD in FIG. 6) is running on the power-state enabled physical processer with configurations shown in FIG. 13 and Table 2, the vCPU(s) for VNFC B can only be scheduled on cores belonging to G2: [P0, P1], i.e., C2 and C3 according to Table 3.

For the case of containerized VNFs, an OS scheduler of the CIS cluster node performs task scheduling on the appropriate cores that match the power profile characteristics of a containerized VNFC, such as a Pod. Logical grouping of cores at the node level can be maintained by the CIS cluster node, for example a Kubernetes® worker node, or at the cluster level by the CISM by grouping nodes into static and dynamic zones.

### 1.4 Monitoring

The power state aware pooling on a per-core level in the infrastructure according to the present disclosure, with the objective to enable power state aware orchestration and overall power conservation, provides the orchestration layer means to analyse the power signatures of virtualized workload components (such as VNFCs, xApps instances, etc.) running in the underlying infrastructure. A monitoring system can obtain real-time and historic utilization of compute resources on any or any combination of these levels: per-cloud, per-cluster, per-node, per-core, to get power-state signatures associated with different NS/VNF components. Current and historical power state data on a per-core level and the virtualized workload deployed on the associated compute nodes/cores enable the orchestrators to do advanced AI/ML analysis and design polices and strategies to make their deployments more energy-efficient. The AI/ML analysis can be performed to minimize the cost function associated to overall power consumption in the network.

An example of such policies can be using the power consumption telemetry data to profile different NFVI PoPs potentially using different technologies, such as Openstack, Kubernetes®, Bare metal or a public cloud instance, such as AWS instance, in terms of their historic power consumption. The orchestration layer, NFV-MANO for example, can then make informed decisions about placing virtualized workloads based on the analysis.

Another example would be to monitor traffic trends at different times, e.g., during different hours of the day, for network services (NSs) and VNFs and the associated power consumption. This kind of analysis can translate to policies for proactive scaling down of NS and VNF components in off-peak hours, consolidating workloads into similar NFVI compute nodes and shutting down extra nodes to conserve power.

In an embodiment, this monitoring aspect may also be used to profile various kind of virtualized workloads and VNFs for their power consumption benchmarking. The benchmarking results can be used to determine per-vCPU power profiles for the virtualized components (VNFCs) that lack the P-state information. These components can then be re-instantiated in the infrastructure using the determined power profiles.

### 2. O-RAN Use Case

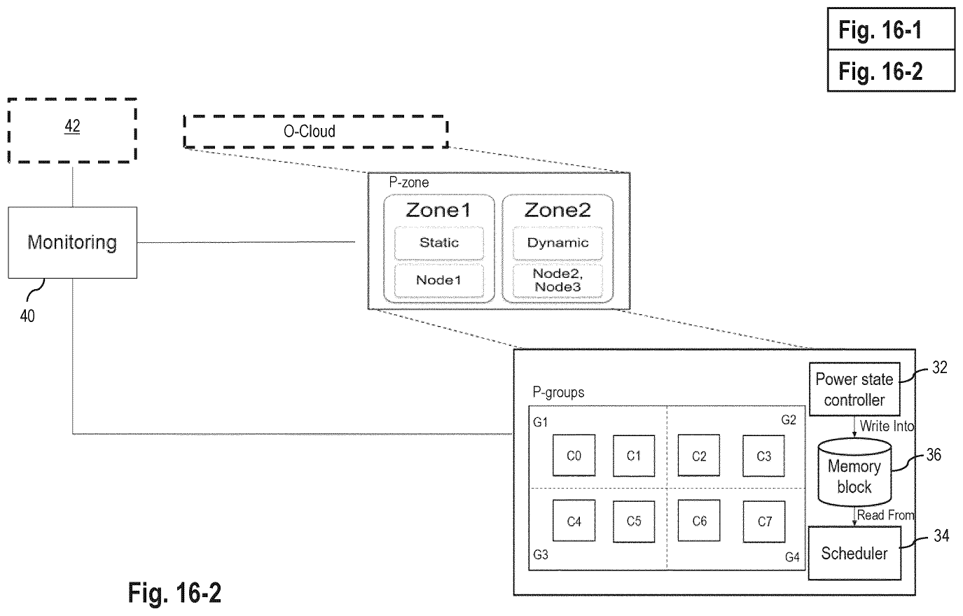

Similar to NFV use case described above in section 1 (specifically, in section 1.1), the inventive capabilities of the present disclosure offer the Service and Management Orchestrator (SMO) to enable power state aware orchestration. These inventive capabilities include: power state aware resource pooling, dynamic and optimal power state management of compute resource, conflict avoidance in a heterogeneous environment, exchange of information between the orchestration layer and infrastructure layer to enable power-state aware orchestration and the fine-grained power consumption data as well as energy-efficiency analysis for policy making. As such, according to embodiments, the concept described in section 1 with respect to NFV use case can be adapted to O-RAN, as illustrated in FIG. 16.

According to embodiments, the concepts disclosed herein may be applied to O-RAN to make the vRAN deployments energy-efficient. SMO and O-Cloud can work in coordination, similar to NFV-MANO and NFVI (as described above in section 1) to achieve the end-to-end objective of overall power conservation. An embodiment of how the concepts described in section can be applied and adopted in O-RAN is depicted in FIG. 16.

Virtualized workloads such as xApps, near-RT RIC are part of the AppPackage as depicted in FIG. 16. According to embodiments, power profiles for the components such as xApps may be provided in the relevant descriptors. SMO 12 can then consider these profiles while instantiating the components in the infrastructure, i.e., O-Cloud.

### 3. Energy-Efficient Managed KUBERNETES® Service

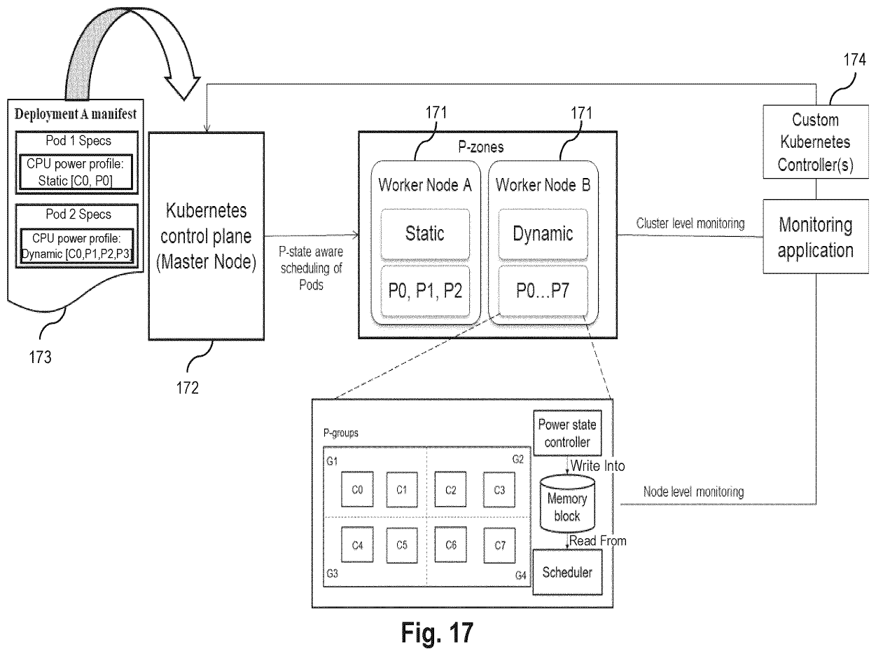

In another embodiment, the system and methods (described above in section 1.3) for grouping CPU cores into logical, power-state based P-groups; controlling CPU power states at runtime based on CPU utilization via P-controller; and scheduling virtualized workloads (VMs or containers) on the physical CPU cores based on desired power profiles can be leveraged by container orchestration engines, such as but not limited to, Kubernetes®. As such, according to embodiments, the concept described in section 1 with respect to NFV use case can be adapted to Kubernetes®, as illustrated in FIG. 17. In order to facilitate power state aware scheduling of Pods as well as to avoid power profile conflicts caused by heterogeneous workloads, Kubernetes® worker nodes can be categorized into P-zones (static and dynamic) and subsequently each worker node can further support P-groups for more dynamic, autonomous, and conflict-free scheduling of container tasks on worker node's CPU(core)s.

Containerized workloads are deployed and managed in a Kubernetes® cluster by making use of different Kubernetes® objects, such as Pods, Deployments, Service etc. Kubernetes supports a declarative method of specifying characteristics and properties of these objects using YAML manifests as descriptors. The Kubernetes control plane uses these descriptors to create objects, deploy workloads, schedule Pods on the worker nodes etc. within the Kubernetes cluster. CPU power state characteristics for Pods may be specified in the relevant descriptors (standalone Pod specifications or Pod specs as part of a deployment specification).

According to an embodiment, an energy-efficient managed Kubernetes service may offer different P-zones based on power management policies. In such a managed service, power capabilities and characteristics of worker nodes such as CPU power management zones (P-zones) and supported P and C state characteristics (P-groups) may be exposed to the Kubernetes control plane. The control plane can then make power-state aware scheduling of workloads (Pods) on the appropriate nodes.

An example Kubernetes cluster is depicted in FIG. 17, with two worker nodes 171 and one master node 172. The worker nodes 171 are categorized into Static and Dynamic P-zones using node tags, the functionality already supported by Kubernetes. Deployment A consisting of two Pods, Pod 1 and Pod 2, have different power profiles, which can be described in their respective descriptors 173. Pod 1 specifies P0 as its desired state. On the other hand, Pod 2 supports dynamic allocation of P-states based on runtime utilization. With the help of power profiles in the Pod specs 173 and node labels, the energy-efficient managed Kubernetes® service will schedule Pod 1 on Worker Node A and Pod 2 on Worker Node B.

Furthermore, within worker node B, there could be multiple P-groups of processor cores that can be utilized by the OS for scheduling container tasks by matching their desired power profiles.

A custom Kubernetes® controller 174 can manage the assignment of worker nodes 171 to appropriate P-zones based on demand throughout the cluster.

The components described in section 1.3, i.e., P-groups, P-controller and scheduler, implemented either within the container run-time, such as Docker, or Host OS, such as Linux, can enable power state aware deployment of Pods on Kubernetes® worker nodes 171. Based on runtime P-state mappings for all the cores, maintained by P-controller, as described in section 1.3.2 (operation #2), the Host OS scheduler can schedule container processes on CPU cores that match the desired power/performance states.

Another utility of this use case can be to control overall power consumption within a Kubernetes® cluster using the control loop nature of Kubernetes®. With the help of custom resources, custom controllers, custom operators, and set of policies, Kubernetes control plane can control overall power consumption of a node, zone, cluster, etc. For example, there may be a policy to not let worker nodes in P-zone D2 (second zone in the dynamic region) exceed a certain power consumption threshold by putting an upper limit on the P-state that the CPU(core)s of those nodes are allowed to run in. This way, only the Pods conforming to the associated power profile will be scheduled on the nodes in this ‘energy-saver’ zone. Node labels and other tags can be used to assist the control plane for this kind of selective scheduling.

### 4. VNF Certification and Clinic

VNF certification is the process of verifying that a VNF meets certain standards and requirements. The certification process typically involves testing the VNF against a set of specifications to ensure that it meets functional, performance, security, and interoperability requirements. The goal of VNF certification is to provide assurance to network operators that a VNF is fit for use in a real-world environment.

Virtual Network Function (VNF) clinic is a process of monitoring, diagnosing, and resolving issues with Virtual Network Functions (VNFs) in a network environment. VNF clinic involves analysing the performance and behaviour of VNFs, identifying any issues, and taking corrective action to resolve them. The goal of VNF clinic is to ensure that VNFs are functioning correctly and delivering the desired level of performance and reliability.

VNF clinic can be performed manually by network administrators, or automated using tools and frameworks specifically designed for VNF management. The use of VNF clinics can help network operators to improve the reliability and performance of their VNFs, and to reduce the downtime and costs associated with VNF-related issues.

Together, VNF certification and clinic can help network operators to improve the reliability and performance of their VNFs and reduce the downtime and costs associated with VNF-related issues. By choosing certified VNFs and conducting regular clinics, network operators can ensure that their VNFs are functioning as intended and delivering the desired level of service to their customers.

Generally, the power usage of VNFs is not considered in current VNF certification processes. VNF certification typically focuses on verifying the functional, performance, security, and interoperability requirements of a VNF. However, with the growing focus on energy efficiency and sustainability in the telecom industry, power usage is becoming an increasingly important consideration for VNFs. Hence, in this regard, implementation according to embodiments of the present disclosure will enable this feature to become a reality, by enriching orchestrators to become power aware. FIG. 2 shows the monitoring and analysis blocks that collect and monitor power consumption on a granular level. This collected data may then be used to analyse and profile per-VNF(C) power consumption. Furthermore, the collected data may be used to generate power aware policies, e.g. using AI/VIL tools. Moreover, the profiling may be used to certify and rate VNFs. In the case of O-RAN, an Operator can use this profiling data to make informed decision in choosing O-RAN components for its deployment.

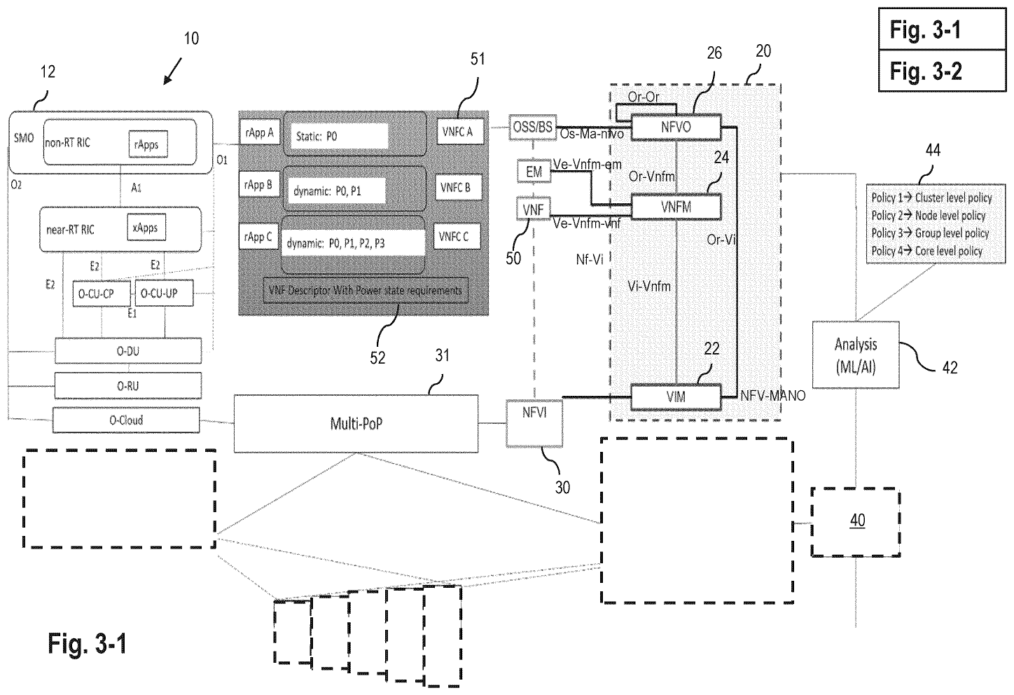

The present disclosure provides methods and systems to optimally schedule virtual network function components (VNFs, O-RAN components, rApps and xApps, etc.) according to their power state requirements in the underlying infrastructure, comprising one or more of the following steps/components:
1) Power state-based resource pooling (in terms of zones and groups) in the underlying infrastructure, based on power state management policies, i.e., static or dynamic, and operating power states of compute resources in order to avoid conflicts between power/performance requirements of virtualized workload and power configurations of the underlying hardware.
2) Power-state aware orchestration algorithms at the orchestration layer (NFV-MANO 20 and O-RAN SMO 12 as an embodiment, see FIG. 3), equipped with the information about power profiles for the virtualized workloads, in terms of applicable power management policy and allowed P-states, provided in the (VNF) descriptor for vCPUs of each component (VNFC 51)
3) Interfaces for relevant information exchange about power-state aware resource pooling between the orchestration layer and infrastructure layer and run-time power conservation policies managed by the orchestration layer, leveraging the enhanced power state management capabilities of the infrastructure
4) A system and method of adjusting power states (e.g. scheduler) in the infrastructure layer to support runtime CPU power state selection at a fine granular level, based on per-core and per-group CPU load utilization for each power state aware node in the infrastructure
5) Autonomous and dynamic power state control for each processor core, adjusting the instantaneous P-state as well as operating P-state limits for each physical core based on runtime demand and CPU utilization.
6) System of registers and memory blocks on the hardware level or in software form to maintain on-going state for each processor core and assist the Scheduler in scheduling vCPUs of virtualized components, i.e., VMs(VNFCs), on the (group of) physical cores in accordance with their power profiles.
7) A system and method leveraging power state profiling information and other telemetry data to certify network functions, rate how green they are and recommends optimization opportunities.
8) The orchestration flow for FIG. 3 may be presented as follows:
   a. Step 1: VNF package will comprises P-state requirements along with other requirements in its package to the OSS/BSS of the Orchestrator (NFV-O 26 or O-RAN SMO 12)
   b. Step 2: Orchestrator will use the P-state information to place the VNFC 51
   c. Step 3: VNF Package is onboarded along with the VNFD 52 containing power profiles for each VNFC 51 (static/dynamic, allowed power states, etc. for vCPUs)
   d. Step 4: VNFM 24 determines the components to be created and deployed as part of VNF instantiation. It provides NFVI 30 or VIM/CISM 22 (depending on the resource allocation method) with the necessary relevant information about power states and type of power state management, i.e., static or dynamic.
   e. Step 5: NFVO 26: In case the granting of resources is requested by the VNFM 24, NFVO 26 may communicate the relevant information (e.g., type of power state management and allowed power states for the VNFCs 51 to be instantiated) to VIMICISM 22.
   f. Step 6: VIM/CISM 22: based on the requirements, VIM/CISM 22 identifies zones in the NFVI 30 for VNFC deployment. In case of dynamic policy, VIM/CISM 22 may convey the set of allowed P-states for each vCPU of VNFC 51.
   g. Step 7: NFVI/Hypervisor/Host OS: Power state controller manages groups of physical cores and either selects a static P-state or dynamically adjusts P-states for each core based on utilization. The scheduler ensures vCPUs are scheduled on the core that matches desired P-state profile.
   h. Step 8: P-state information will be monitored, collected and transferred as an Input for AI/ML analysis to generate policies
   i. Step 9: Policies generated in Step 8 will be applied by the Orchestrator to save energy

The present disclosure provides methods and systems to dynamically and optimally adjust CPU power states at runtime in large-scale, orchestrator-managed, virtualized environments with the objective to conserve power and enable the orchestration layer to achieve power state aware deployment of heterogeneous workloads as well as to implement efficient power management policies in the underlying infrastructure, comprising one or more of the following steps/components:
1) Logical grouping of physical cores in terms of their operating P-state limits to avoid potential conflicts in the power/performance requirements of heterogeneous virtualized workloads that may arise during simple load-based P-state control.
2) Novel mechanism for adjusting runtime P-states for each core as well as operating P-state limits governed by real-time load and demand indicators.
3) Scheduling of vCPUs on the appropriate physical cores that match their power profiles.
4) Mechanism to extend power state-based resource pools from node level to the whole infrastructure, building a federation of nodes, belonging to same cloud or multiple clouds, as a means to make the orchestration layer aware of underlying infrastructure power state characteristics.
5) Exchange of information and parameters over the interfaces between the infrastructure layer and orchestration layer associated to enable power state aware orchestration and dynamic P-state management to make the overall system energy-efficient.
6) A monitoring mechanism to obtain real-time and historic utilization of compute resources on a per-cloud/per-cluster/per-node/per-core to get power-state signatures associated with different NS/VNF components. This telemetry data can be utilized to do AI/ML analysis for profiling the virtualized workload types with their corresponding runtime power requirements.

Many modifications and other embodiments of the present disclosure set forth herein will come to mind to the one skilled in the art to which the present disclosure pertains having the benefit of the teachings presented in the foregoing description and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention or disclosure is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for managing virtual network function components (VNFCs) in a compute infrastructure of a virtualized environment, the method comprising:
performing, by an orchestrator system of the virtualized environment, power state-based resource pooling in the compute infrastructure based on central processing unit (CPU) power state management policies; and
scheduling, by a scheduler, virtual CPUs (vCPUs) of the VNFCs on physical cores of appropriate resource pools whose CPU power states match with power profile characteristics of the vCPUs.

2: The method according to claim 1, further comprising:
by a power state controller, controlling and dynamically adjusting the CPU power states of the physical cores of a resource pool at runtime based on real-time utilization metrics.

3: The method according to claim 1, wherein the power state-based resource pooling is performed by dividing compute resources of the compute infrastructure into various power state aware zones, wherein the zones comprise at least a static P-zone with preset and static power states of the associated compute resources and a dynamic P-zone that allows runtime management of the power states of the associated compute resources.

4: The method according to claim 3, wherein the power state-based resource pooling is performed by further dividing the associated compute resources belonging to the dynamic P-zone into power state-based groups, wherein the groups are based on operating P-state limits of the physical cores of the respective compute resources.

5: The method according to claim 1, further comprising:
maintaining, for each physical core, CPU power characteristics comprising operating P-state limits, in a memory component;
periodically updating the CPU power characteristics to account for runtime dynamic changes; and
using, by the scheduler, a most recent state of the memory component to schedule the vCPUs of the VNFCs on the physical cores by matching power profile requirements.

6: The method according to claim 2, further comprising, by the power state controller:
setting a P-state for each physical core according to a utilization for each physical core on a core level, or
associating the physical cores to their power state-based groups based on workload demand.

7: The method according to claim 1, further comprising:
exposing at runtime power states from multiple levels of a compute infrastructure hierarchy to the orchestrator system of the virtualized environment, wherein the multiple levels comprise at least one of a core level, node level, cluster level, PoP level and cloud instance level.

8: The method according to claim 1, further comprising:
using, by the orchestrator system of the virtualized environment, information about the power profile characteristics of the vCPUs provided in a VNF descriptor, to perform power state aware orchestration of the vCPUs of the VNFCs.

9: The method according to claim 1, further comprising:
obtaining, by a monitoring system, data on real-time and historic utilization of compute resources on at least one of a per-cloud/per-cluster/per-node/per-core basis to get power-state signatures associated with different VNFCs of the VNFCs; and
using the obtained data as training data for training an artificial intelligence/machine learning (AI/ML) analysis tool to generate power saving policies to be applied at multiple levels in a compute infrastructure hierarchy.

10: The method according to claim 1, wherein the orchestrator system of the virtualized environment manages multiple compute infrastructures via a plurality of Points of Presence (PoP) supporting different virtualisation technologies.

11: A system for managing virtual network function components (VNFCs) in a compute infrastructure of a virtualized environment, the system comprising:
an orchestrator system configured to perform power state-based resource pooling in the compute infrastructure based on central processing unit (CPU) power state management policies; and
a scheduler configured to schedule virtual CPUs (vCPUs) of the VNFCs on physical cores of appropriate resource pools whose CPU power states match with power profile characteristics of the vCPUs.

12: The system according to claim 11, further comprising a power state controller configured to control and dynamically adjust the CPU power states of the physical cores of a resource pool at runtime based on real-time utilization metrics.

13: The system according to claim 11, further comprising:
a monitoring system configured to obtain data on real-time and historic utilization of the compute resources on at least one of a per-cloud/per-cluster/per-node/per-core basis to get power-state signatures associated with different VNFCs of the VNFCs; and
an artificial intelligence/machine learning (AI/ML) analysis tool configured to use the data obtained by the monitoring system as training data to generate power saving policies to be applied at multiple levels in a compute infrastructure hierarchy.

14: The system according to claim 11, wherein the orchestrator system comprises a network functions virtualization management and orchestration (NFV-MANO) or a service and management orchestrator (SMO) of an open radio access network (O-RAN).

15: The system according to claim 11, wherein the VNFCs are components of a containerized virtual network function (VNF) wherein the containerized VNFs are deployed via containerized infrastructure service (CIS) clusters, wherein a CIS manager orchestrates the containerized VNFCs in the form of pods on worker CIS cluster nodes.
